(19) United States
(12) Patent Application Publication
(10) Pub. No.: US 2015/0010685 A1
(43) Pub. Date: Jan. 8, 2015

(54) METHOD AND APPARATUS FOR PRODUCING BAKED GOODS

(71) Applicants: Michael Hobel, Hoersching (AT); Norbert Kraihamer, Mattsee (AT); Peter Augendopler, Wien (AT)

(72) Inventors: Michael Hobel, Hoersching (AT); Norbert Kraihamer, Mattsee (AT); Peter Augendopler, Wien (AT)

(21) Appl. No.: 14/375,223

(22) PCT Filed: Jan. 29, 2013
(86) PCT No.: PCT/AT2013/050026

§ 371 Date: Jul. 29, 2014

(30) Foreign Application Priority Data
Feb. 6, 2012 (AT) A 50024/2014

(51) Int. Cl. A21B 3/13; A21D 8/06

(52) U.S. Cl. CPC A21B 3/136; A21D 8/06; A21B 3/139
USPC 426/523; 425/357; 425/408

(57) ABSTRACT

A method and an apparatus for producing baked goods in a predefined shape are described, wherein a piece of dough is baked in a closed mold cavity (5) after a rising in direct succession with heat supply, wherein the piece of dough completely fills up the mold cavity (5) with a gas displacement during the baking. To ensure advantageous baked products, it is proposed that the piece of dough, with implementation of a finely-structured crust, be applied to the gas-tight mold wall which delimits the mold cavity (5), and the gas be discharged from the mold cavity (5) in the region of depressions (8) provided in the mold wall (7), which define protrusions of the baked good projecting beyond a surface region and into which the gas is displaced by the oven rising of the piece of dough.

### FIELD OF THE INVENTION

The invention relates to a method for producing baked goods in a predefined shape, wherein a piece of dough is baked in a closed mold cavity after a rising in direct succession with heat supply, wherein the piece of dough completely fills up the mold cavity during the baking with a gas displacement, and to an apparatus for carrying out the method.

### DESCRIPTION OF THE PRIOR ART

The term dough is understood hereafter to include yeast doughs and sourdoughs, which, in contrast to bulks, have a sufficient dimensional stability until the dough structure is permanently solidified by the heat supply during baking. To loosen the doughs and pieces of dough, i.e., the pieces of dough prepared for the production of baked goods, corresponding rising must be ensured, to be able to provide sufficient carbon dioxide to form pores, for example, in the case of yeast rising by splitting simple sugars or in the case of sourdoughs by lactic acid bacteria and yeasts. Baked goods made of such preformed pieces of dough can therefore be subjected to a baking operation, conventionally using hot air, only after a rising, which is carried out in a separate rising chamber. As a result of the rising operation and the volume increase caused by the oven rising, the formation of the respective baked good can only be predefined coarsely, wherein a finely-structured surface formation is not possible as a result of the operations during the crust formation. However, the possibility of a finely-structured surface formation plays a decisive role in particular in the case of the simulation of specific objects by baked goods.

In addition, for the production of baked goods in a predefined molding tool, baking individual parts of these baked goods in closed molds and then assembling them, with filling of cavities resulting between the parts, to form the finished product is known (WO 2004/098295 A1). The pieces of dough are baked in this case after a rising in direct succession with heat supply, wherein the pieces of dough fill up the mold cavity with a gas displacement during the baking. The gas displacement occurs via slots between the connecting flanges of the mold tool parts, which precludes a finely-structured reproduction of the surface formation of the mold walls as a result of remaining gas cushions. The ventilation of the mold cavity of the molding tools can also occur via porous walls of the molding tool, however. Porous molding tools permit, in the event of a sufficient porosity of the mold walls, an escape of the gas via the entire wall surface, which allows an intimate application of the piece of dough to the mold wall. Nonetheless, finely-structured surface crusts of the baked goods cannot be achieved, because gas can also exit through the mold wall after the application of the piece of dough to the mold wall, so that corresponding counter pressure cannot be built up via the mold wall. In particular, the steam arising due to the moisture of the piece of dough during the baking tears the surface crust with the effect that a uniformly finely-structured crust cannot be achieved over the entire surface, and the baked product is unsatisfactory.

### SUMMARY OF THE INVENTION

The invention is therefore based on the object of specifying a method, with the aid of which baked goods can be produced, corresponding to a predefined shape, in a dimensionally-accurate manner with a finely-structured surface.

Proceeding from a method of the type described at the outset, the invention achieves the stated object in that the piece of dough is applied to a gas-tight mold wall, which delimits the mold cavity, while forming a finely-structured crust, and the gas is discharged from the mold cavity in the region of depressions provided in the mold wall, which define protrusions of the baked good projecting from a surface region and into which the gas is displaced by the oven rising of the piece of dough.

Since, as a result of these measures, the gas exiting from the piece of dough during the baking can only escape from the molding tool in the region of depressions in the mold wall of the molding tool, i.e., in the region of protrusions projecting beyond the surface of the baked good, the piece of dough is applied intimately to the mold wall by the oven rising, during which the volume of the piece of dough enlarges as a result of the heating of the carbon dioxide, which is formed during the rising and enclosed in dough pores, not only with a gas displacement into the depressions, but rather also completely fills up the depressions, because the gas displaced into the depressions can be expelled completely from the depressions by the piece of dough. A crust formation, which follows the surface structure of the mold cavity wall, having a finely-structured surface is assisted by the application of the piece of dough to the wall of the mold cavity, because the gas-tight mold wall causes a counter pressure to the carbon dioxide within the piece of dough and prevents tearing of the surface by escaping carbon dioxide, so that after the ending of the baking operation and a demolding, a baked good is obtained, which not only precisely reproduces the formation of an object determined by the mold cavity, but rather also has a finely-structured surface having a uniformly fine surface crust.

However, the prerequisite is that the rising of the piece of dough is carried out in this mold cavity and therefore handling of the piece of dough between the rising and the baking operation is omitted. The rising can be designed differently in this case depending on the dough process and is ended with the heating of the mold cavity to baking temperature. Influence can be taken on the baked product in a manner known per se by the temperature control, the moisture content, and the baking duration.

For the production of baked goods in a predefined shape from corresponding pieces of dough, it is possible to proceed from an apparatus having at least one divided molding tool, if the molding tool, which forms a closed mold cavity, has degassing openings in the region of depressions provided in the mold wall, which define protrusions of the baked good projecting beyond a surface region. Since the hazard exists in the region of depressions in the mold wall that these depressions will be closed by the piece of dough before the gas is displaced from these depressions by the piece of dough, the degassing openings, through which the gas can be displaced outward from the mold cavity, are to be provided in the region of these wall depressions, in particular on the depression base, so that an intimate dough application is also ensured in the region of such depressions of the mold wall.

For the commercial or industrial production of baked goods in the form of predefined objects, the respective usage of a plurality of molding tools is necessary, which are typically composed of two mold parts. To provide advantageous handling conditions for these usage cases, the mold parts can have a peripheral connecting flanges along their partition plane, so that the molding tools having the connecting flanges can be clamped between two frames, which are connected to one another like a hinge and form receptacles for the individual molding tools. Under these conditions, the mold parts of the molding tools, which are filled with the pieces of dough and inserted into the frame receptacles, can be jointly connected to one another by closing and locking of the closed frames for the rising and the subsequent baking operation, because the connecting flanges of the mold parts are held pressed against one another via the frames with the aid of the connecting bolts and the locking bars. The internal pressure load of the molding tools remains restricted because of the gas displacement from the mold cavity and is only dependent on the oven rising.

In order that the frames do not have to be designed as torsion-resistant in a structurally complex manner, the two frames can be locked with the aid of locking bars, which engage behind the protruding heads of connecting bolts, which are associated with one frame and penetrate the other frame in the closed position. With the aid of the locking bars fixed via the connecting bolts, the two frames are not only locked with one another at multiple points in the closed position in a work step, but rather additionally stiffened, so that the frames themselves represent a comparatively light structure.

Particularly favorable relationships result in this context if the frames have receptacles arranged in rows for the molding tools and the locking bars are provided on both sides of each row of receptacles. It is specifically ensured by this measure that the two frames are each connected to one another adjoining the receptacles, so that the clamping of the connecting flanges of the mold parts between the two frames occurs in the region of influence of the locking bars.

If the locking bars are connected to one another to form a frame-type actuating unit in relation to a row of receptacles, a further handling simplification can thus be achieved. The two frames are always connected to one another on both sides of a row of receptacles by the actuating unit comprising the two associated locking bars in one work step.

### BRIEF DESCRIPTION OF THE DRAWING

The method according to the invention will be explained in greater detail on the basis of the drawing. In the figures:

FIG. 1 shows a molding tool according to the invention in a partially cut away side view,

FIG. 2 shows the top mold part of the molding tool according to FIG. 1 in a view of the interior,

FIG. 3 shows an apparatus according to the invention for producing a plurality of baked goods in a predefined shape in a simplified top view in a smaller scale,

FIG. 4 shows the apparatus according to FIG. 3 in a section along line IV-IV of FIG. 3, and

FIG. 5 shows a section along line V-V of FIG. 3.

### DESCRIPTION OF THE PREFERRED EMBODIMENT

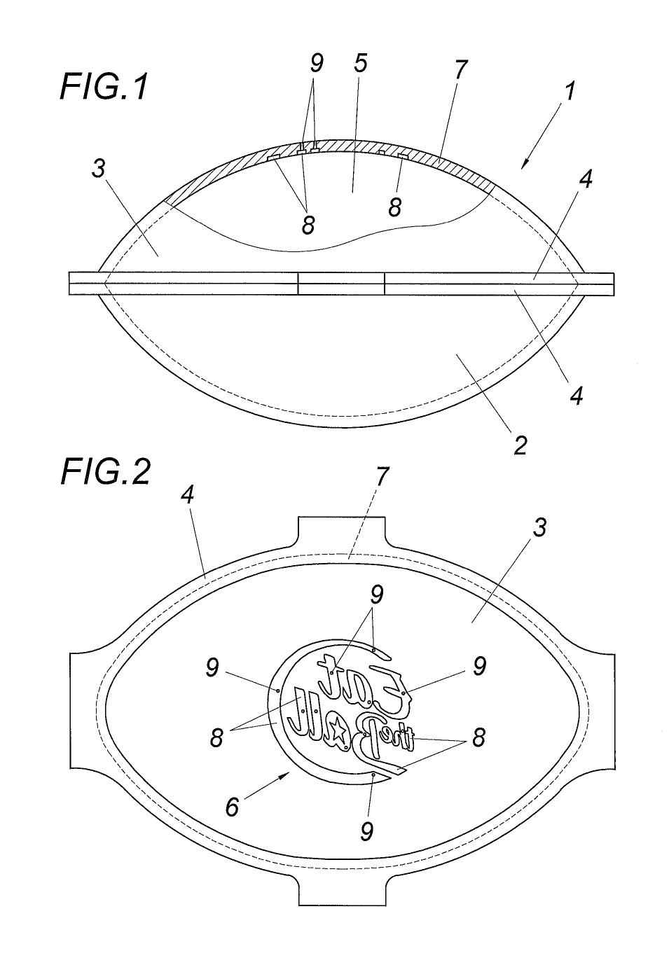

The molding tool 1 according to FIGS. 1 and 2 has a bottom and a top mold part 2, 3, wherein these mold parts 2, 3 are each provided with a peripheral edge flange 4, to connect the two mold parts 2, 3 to one another to form the molding tool 1, which forms a closed mold cavity 5. This mold cavity 5 defines a spatial shape for the baked good to be produced. In the case of the exemplary embodiment, the mold cavity 5 represents a spatial shape simulating a football, which can also be reproduced as other objects, of course. The football simulated by the baked good is to have a logo 6 in the form of a raised surface structure of the baked good according to the exemplary embodiment. Accordingly, the logo 6 is provided by depressions 8 as a negative mold in the mold wall 7, preferably of the top mold part 3. These depressions 8 are provided with degassing openings 9, wherein the individual depressions 8, which are separate from one another, each have at least one degassing opening 9.

For example, to produce a baked good from a yeast dough in the form of a football predefined by the molding tool 1, the prepared piece of dough, which is adapted with respect to its weight to the spatial content of the mold cavity 5, is introduced into the bottom mold part 2 and the molding tool 1 is closed by putting on the top mold part 3, which is connected to the mold part 2 via the connecting flanges 4 with a closing force sufficient for the baking operation. Firstly, the rising of the yeast dough is carried out in the closed molding tool 1 to ensure corresponding loosening of the dough. After the rising, the baking operation is initiated, by heating the molding tool 1 to baking temperature with the aid of hot air. The volume enlargement of the piece of dough caused by the oven rising causes the piece of dough to be applied to the mold wall 7 of the molding tool 1, wherein the gas present in the mold cavity 5 is displaced out of the mold cavity 5 through the degassing openings 9, so that the piece of dough completely fills up the mold cavity 5. This is an essential requirement for the structuring of the inner surface of the mold wall 7 of the molding tool 1 to be imaged in a dimensionally-accurate manner on the baked good, specifically in the region of the surface of a fine pored crust. After the baking operation, the molding tool 1 is opened and the baked good is removed, which has the formation of a football having a finely-structured surface, on which not only is the logo 6 visible, but rather also the seams characteristic for a football protrude clearly, if a corresponding negative mold for such seams is provided in the mold wall 7.

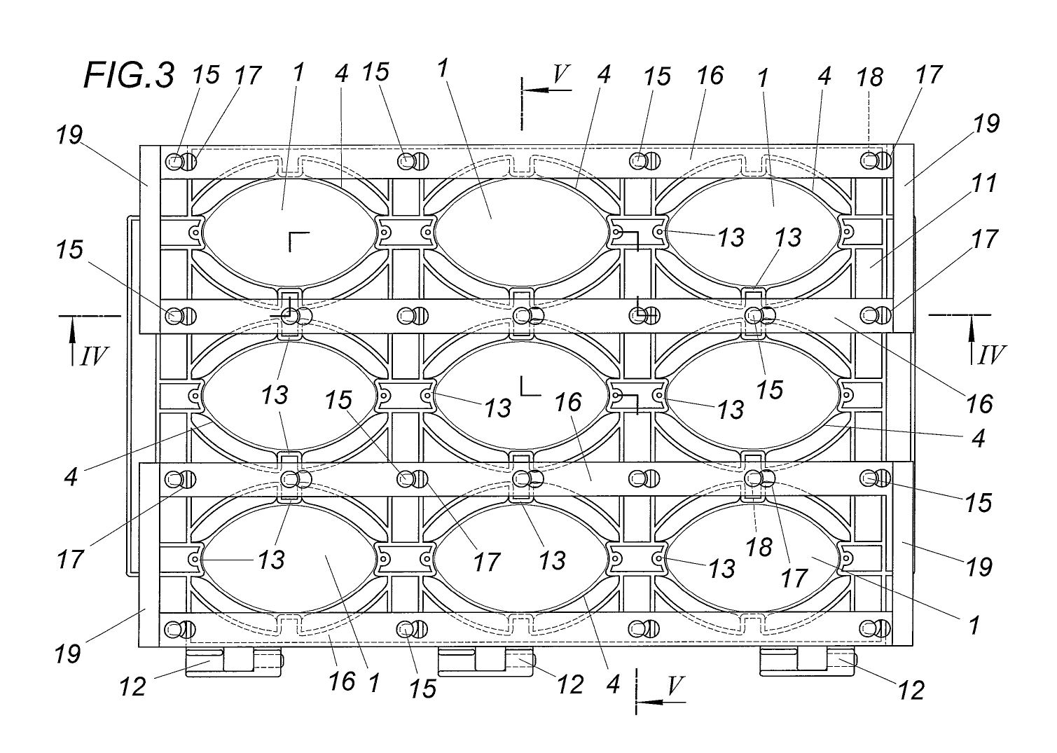

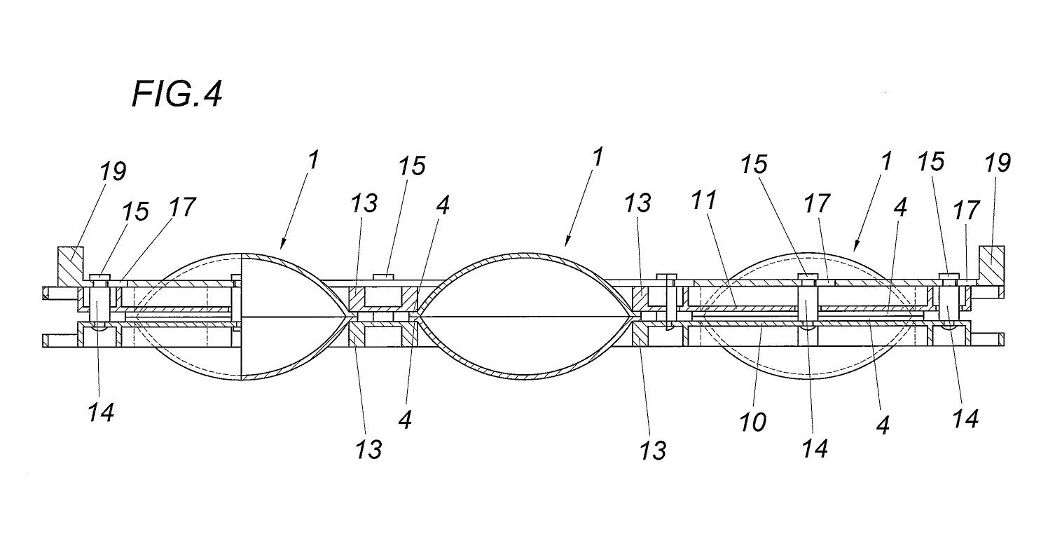

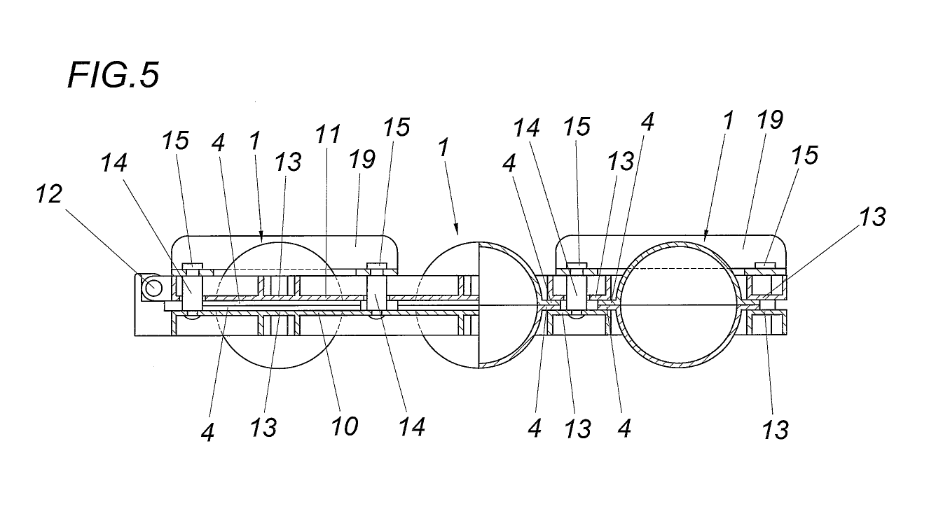

In commercial and industrial use, a plurality of mold tools 1 is to be provided. For this purpose, according to FIGS. 3 to 5, a larger number of molding tools 1 can be clamped between two frames 10 and 11, which are articulated with one another on one side via hinge joints 12. These frames 10, 11 form receptacles, which are arranged in rows, for the molding tools 1, having compression parts 13, between which the connecting flanges 4 of the mold parts 2, 3 are clamped. For this purpose, the connecting flanges 4 can be widened accordingly in the region of the compression parts 13, as can be inferred from FIG. 2.

Clamping means which are different per se can be used for locking the closed position of the two frames 10, 11. Particularly simple structural conditions result if one of the two frames 10, 11, preferably the bottom frame 10, has upwardly protruding connecting bolts 14, which penetrate the top frame 11 in the closed position and form a head 15 protruding beyond the frame 11, which a locking bar 16, which is supported on the frame 11, engages behind. For this purpose, the locking bars 16 form, for the head 15 of the connecting bolts 14, a passage opening 17 having an adjoining oblong hole 18, so that the locking bars 16 are placed on the head 15 of the connecting bolts, to engage behind the heads 15 of the connecting bolts 14 after a displacement in the direction of the oblong holes 18 when the neck of the locking bolts 14 bearing the head 15 engages in the oblong hole 18.

As can be inferred from FIG. 3 in particular, the locking bars 16 are arranged on both sides of each longitudinal row of the receptacles for the molding tools 1, so that the two frames 10, 11 can be locked with one another on both sides of each molding tool 1. To make the handling of the locking bars 16 easier during the locking of the two frames 10, 11 or during the unlocking thereof, respectively, the locking bars 16 can be connected in pairs via transverse legs 19 to form frame-like actuating units, so that the two frames 10, 11 can each be locked simultaneously via a locking bar pair. It probably does not have to be especially emphasized that the locking bars 16 can be provided with corresponding approach surfaces for the heads 15 of the connecting bolts 14, in order to apply a corresponding closing force for the dough-tight connection of the connecting flanges 4 of the mold parts 2, 3 with the mutual locking of the frames 10, 11.

1. A method for producing baked goods in a predefined shape, wherein a piece of dough is baked in a closed mold cavity (5) after a rising in direct succession with heat supply, wherein the piece of dough completely fills up the mold cavity (5) with a gas displacement during the baking, wherein the piece of dough, with implementation of a finely-structured crust, is applied to the gas-tight mold wall which delimits the mold cavity (5), and the gas is discharged from the mold cavity (5) in the region of depressions (8) provided in the mold wall (7), which define protrusions of the baked good projecting beyond a surface region and into which the gas is displaced by the oven rising of the piece of dough.

2. An apparatus for producing baked goods of a predefined shape having at least one divided molding tool (1), which forms a closed mold cavity (5) having degassing openings (9), wherein the degassing openings of the molding tool (1) are arranged in the region of depressions (8) provided in the mold wall (7), which define protrusions of the baked good projecting beyond a surface region.

3. The apparatus according to claim 2, wherein a plurality of molding tools (1) each made of two mold parts (2, 3) is provided, which have peripheral connecting flanges (4) along their partition plane, and the molding tools (1) can be clamped with the connecting flanges (4) between two frames (10, 11), which are connected to one another like hinges and form receptacles for the individual molding tools (1).

4. The apparatus according to claim 3, wherein the two frames (10, 11) are lockable with the aid of locking bars (16), which engage behind protruding heads (15) of connecting bolts (14), which are associated with one frame (10) and penetrate the other frame (11) in the closed position.

5. The apparatus according to claim 4, wherein the frames (10, 11) have receptacles arranged in rows for the molding tools (1), and the locking bars (16) are provided on both sides of each row of receptacles.

6. The apparatus according to claim 5, wherein the locking bars (16) of each row of receptacles are connected to one another to form a frame-type actuating unit.
